(19) United States
(12) Patent Application Publication
(10) Pub. No.: US 2004/0129567 A1
(43) Pub. Date: Jul. 8, 2004

(54) Electorphoretic separation system

(76) Inventors: Kevin Andrew Auton, Cambridgeshire (GB); Paul Thomas Ryan, Cambridgeshire (GB)

Correspondence Address: NIXON & VANDERHYE, PC, 1100 N GLEBE ROAD, 8TH FLOOR, ARLINGTON, VA, 22201-4714, US

(21) Appl. No.: 10/475,113

(22) PCT Filed: Apr. 16, 2002
(86) PCT No.: PCT/GB02/01749

(30) Foreign Application Priority Data
Apr. 17, 2001 (GB) 0109351.7
Feb. 19, 2002 (GB) 0203853.7

(51) Int. Cl. G01N 27/26

(52) U.S. Cl. 204/450; 204/600

(57) ABSTRACT

Electrophoretic separation device comprising first and second separation zones for containing first and second separation media, and barrier means, preferably automatically operable, by which fluid communication between the two zones may be reversibly prevented, the barrier means comprising a sealing element which is deformable between two positions to allow or prevent the fluid communication. The sealing element may comprise a flexible sheet carrying the first separation medium. Also provided are apparatus comprising such a separation device, and methods of electrophoretic separation, in one of which a first dimension separation is carried out in a chamber in the absence of any other separation medium, followed by introduction into the same chamber of a second separation medium, adjacent or in contact with the first, the analytes being allowed to migrate from the fist to the second separation medium prior to conducting the second dimension separation.

### FIELD OF THE INVENTION

This invention relates to analyte separation systems and their use, in particular to two-dimensional gel electrophoresis systems.

### BACKGROUND TO THE INVENTION

Gel electrophoresis is a known technique for separating a mixture of analytes. An electric field is applied across a gel through which the mixture, in the form of a fluid sample, can migrate. The speed of migration of each analyte, under the influence of the electric field, may depend on a variety of analyte properties such as molecular weight or isoelectric point. As a result, the analytes separate along the gel in the direction of the applied field.

Resolution can be improved by conducting two successive separations. Initially the analytes are separated according to a first property, and the thus-separated mixture is then applied to another gel and subjected to an electric field to separate its components according to a second, different, property. This technique, known as two-dimensional gel electrophoresis, was first reported in 1975 (O'Farrell, P H [1975] J. Biol. Chem. 250: 4007-4021). It is commonly used to separate mixtures of biological analytes such as proteins.

In the case of protein analytes, the “first dimension” separation is typically done by isoelectric focussing, in which a pH gradient causes separation of the proteins according to their isoelectric points (the pHs at which the proteins have no net charge). According to the “immobilised pH gradient” (“IPG”) technique, the pH gradient may be incorporated in a gel, for instance in the form of a strip bound to an inert substrate, to which the protein mixture is applied. The “second dimension” separation is then typically performed by the common technique of slab gel electrophoresis, for instance using a detergent such as SDS (sodium dodecyl sulphate) to complex with the proteins.

The mobility of the complexed proteins through a second gel, in an electric field, depends on their molecular weight and degree of charge.

A typical two-dimensional gel electrophoresis involves a number of steps, including:

a) Mechanical or chemical disruption of the analyte mixture.

b) Treatment with various reagents to enable the analytes to be subjected to electrophoretic separation and to remove materials that may interfere with the process.

c) Application to the first dimension separation system—if this is an IPG system, a pre-prepared and dried IPG strip may be re-hydrated with the sample fluid so that the sample is drawn into the gel as it expands.

d) Application of a time-varying polarising potential along the first dimension separation medium so as to separate the analytes according to their first property.

e) Transfer of the separated analytes onto a pre-prepared gel on which the “second dimension” separation is to be carried out. This is typically effected by bringing the gel on which the first dimension separation was carried out into contact with the second gel.

f) Application of a polarising potential across the second dimension gel so as to separate the target analytes according to their second property.

g) Imaging of the second dimension gel to detect the thus-separated analytes. This may involve removing the gel from the apparatus in which the separation was carried out. It may involve washing and staining the gel to reveal the locations of individual analytes. Techniques are known for detecting and analysing the results of such an electrophoretic separation.

These processes are still typically carried out manually. Many of the steps are complex and time consuming and require skilled operators. The potential for inaccuracy and waste (in particular, analyte loss during the first to second dimension transfer step (e)) is high.

Lack of reliability and accuracy can be a major issue, particularly since gel electrophoreses are often used for sample comparison Inaccuracy and inconsistency can arise from variations, between experiments, in processing conditions such as sample preparation and application techniques, IPG strip parameters (age, density, drying and reconstitution conditions, ampholyte parameters), slab gel age, density and thickness, the compositions and concentrations of electrophoresis solutions, and electrophoresis conditions such as time, temperature, applied voltages and electric field homogeneity.

Attempts to automate the process have to date met with only limited success. A certain amount of automation is available to help execute steps (d) and (f) described above, and for post-separation imaging, but the remaining steps still have to be performed manually.

U.S. Pat. No. 5,993,627 describes a system in which a complex series of operations is carried out robotically, the sequence mimicking that of a typical manual process. Following a first dimension PG separation, the IPG strip is incorporated into a slab gel in which the second dimension separation is then effected. The system is appropriate for bulk processing but less so for the smaller scale research laboratory.

Laemmli (Nature 227, 680, reviewed for instance in Proteome research: Two-dimensional gel electrophoresis and identification methods, T Rabilloud (Ed), Springer-Verlag GmbH & Co. KG, ISBN 3-540-65792-4) describes the use of a “stacking” gel which can improve resolution and reliability in second dimension separations.

U.S. Pat. No. 6,013,165 discloses apparatus in which the first and second dimension separations occur sequentially in adjacent regions of a single separation cavity. A sample may migrate directly from the first to the second region, controllable only by the electric fields applied across the two regions.

It would be desirable to minimise the amount of (in particular skilled) manual intervention needed for two-dimensional gel electrophoresis, to simplify or even to avoid at least some of the process steps (a)-(g) described above and thus to improve reliability and accuracy, to increase throughput and to reduce sample loss and also cost-per-sample. Ideally, no manual intervention would be required once a sample had been loaded into the first dimension separation systems

### STATEMENTS OF THE INVENTION

According to a first aspect of the present invention, there is provided an electrophoresis device for use in separating a mixture of analytes in a fluid sample, the device comprising first and second separation zones each containing a separation medium through which the analytes may migrate, and barrier means by which fluid communication between the first and second zones may be reversibly prevented.

The barrier means, at least initially, prevents the passage of analytes in the sample between the first and second separation zones. It is preferably operable between two positions, in one of which analyte movement is prevented and in the other of which it is allowed. It is preferably automatically operable, for instance under the control of programmable control means such as a microprocessor.

The electrophoresis device of the invention may be relatively simple in construction, but the provision of two separation zones which can be isolated from one another or in fluid communication with one another as necessary, by operation of the barrier means, allows a first dimension separation to be carried out to completion before the thus separated analytes are allowed to enter the second dimension separation zone. Analytes can be allowed to progress continuously from the first to the second dimension zone at an appropriate time, without the need for manual sample transfer. Once a sample has been loaded into the device, no further manual intervention is necessary.

When the barrier means occupies a position in which fluid communication between the two zones is allowed, this suitably creates a cavity into which an appropriate medium can be introduced to allow the sample to migrate across the cavity between the zones. It is clearly desirable that the analyte separations achieved in the first one should be preserved whilst the analytes travel on to the second zone. To this end, the design of the cavity and the conditions under which it is used should be selected to minimise distortion of the analyte separations achieved in the first zone, which means minimising analyte movement in particular in the direction along which the first zone separation was effected.

The amount of analyte “drifting” which can be tolerated depends to an extent on the resolution achievable in the separation media used; analyte movement in the relevant dimension, as the analytes traverse the cavity, should ideally be over distances smaller than the best achievable resolution. A typical currently available gel provides a useful resolution of down to about 0.5 mm; analyte movement is suitably less than 0.5 m ideally less than 0.3 mm, when using such gels.

The degree of analyte movement within the inter-zone cavity can depend on a number of factors, such as the viscosity of the medium or media present in the cavity, the length of the cavity (in the direction of sample movement), the applied electric field, the applied pressure gradient and the nature, and therefore mobility, of the analytes themselves. These factors, in particular the pressure gradient, can in turn be affected by external influences such as temperature, gravity, device movement and even fluid movement in connecting apparatus.

A suitable medium for use in the inter-zone cavity is a relatively viscous fluid such as molten agarose (at a temperature of, for instance, between 50 and 70° C.). Suitable fluid viscosities may be between 2 and 1000 mPa.s (measured at room temperature and pressure), preferably between 5 and 500 mPa.s, more preferably between 5 and 20 mPa.s, such as about 10 mPa.s. Buffer fluids may also be present—examples include those currently used to carry out gel electrophoresis separations, many of which are described in Proteome Research: Two-dimensional gel electrophoresis and identification methods (supra).

Generally speaking, analyte movement can be reduced by reducing the degree of fluid movement possible within the cavity. This in turn can be controlled by for example:

i) filling the cavity with a more viscous fluid, such as by incorporating a gelling agent such as polyacrylamide or agarose;

ii) reducing, preferably minimising, the length of the cavity (in the direction of analyte movement through it)—a suitable length might be, for example, between 0.5 and 5 mm, preferably between 1 and 3 mm, more preferably about 2 mm;

iii) including fluid flow control valves in the vicinity of the cavity, so as to effect control over fluid movement which might arise for example due to external influences; and/or

iv) mounting the device in a rigid support, again so as to minimise fluid movement during use.

The device of the invention is preferably designed with such factors in mind, and is used accordingly.

The barrier means should provide, at least in a first position, a fluid-tight seal between the first and second separation zones. It may take the form of a strip, block or similar component which can be removably located between the two zones. When removed, such a component leaves a cavity in fluid communication with both the first and second zones, as described above. The cavity may then be filled with a suitable medium, such as molten agarose and/or a buffer solution, through which the sample analytes may pass to the second zone.

Suitable materials from which a removable barrier might be made include natural or synthetic rubber, plastics materials or composites thereof. The barrier dimensions naturally depend on those of the cavity it is to create on removal and of the adjacent separation zones.

Alternatively, the barrier means may be made from a material which can be at least partially melted or otherwise degraded under appropriate conditions, such as by the local application of an increased temperature or of an appropriate reagent.

More preferably, the barrier means comprises a sealing element (for instance, an appropriately shaped gasket) which is deformable and/or displaceable between two positions, in one of which fluid communication is prevented between the first and second separation zones and in the other of which such fluid communication is allowed. Suitably the sealing element is deformable and/or displaceable by the application of pressure changes, for instance by the selective application of a pressurised control fluid (liquid or gas, ideally compressed air) to an appropriate region of the element. This may be effected via a control chamber defined at least in part by a region of the sealing element, the introduction or removal of control fluid into the control chamber causing deformation and/or displacement of the sealing element.

The sealing element may be deformable and/or displaceable at two or more locations, so as to be operable to allow or inhibit, preferably reversibly, fluid communication between two or more pairs of adjacent regions of the device. Ideally the two or more locations of the sealing element may be individually operated.

The sealing element may be made of any suitably flexible material, inert with respect to the fluids and analytes with which it will come into contact. Suitable materials include synthetic rubbers such as silicone, nitrile or EPDM; suitable thicknesses might be between 0.3 and 1.5 mm, preferably between 0.5 and 1 mm, in deformable and/or displaceable regions.

The sealing element may take the form of a flexible sheet on one face of which the first dimension separation medium (typically an IPG strip) is carried, the surface area of that face being greater than that of the region of contact between the separation medium and the sheet.

According to this embodiment of the invention, typical dimensions for the gel strip are a thickness of between 0.1 and 1.5 mm, preferably between 0.4 and 0.8 mm; a length (this being the direction of analyte movement in use) of between 50 and 500 mm, preferably between 100 and 350 mm, more preferably between 150 and 320 mm, most preferably about 300 mm; and a width of between 2 and 5 mm, preferably 3.5 mm.

The strip is then supported on, and preferably permanently secured to, the flexible sheet. It may be applied to the sheet either by being formed in place or by a separate adhesion process after manufacture of the medium. One method of forming in place is to use a moving nozzle to dispense a mix of gel ingredients onto the sheet. As the nozzle moves along the desired track of the separation medium, the mix of ingredients is altered to give the necessary gradient of immobilized pH. Another method for forming in place is to apply or dispense a base gel (eg, polyacrylamide) then to spray immobilisable ampholytes into the gel to create the necessary gradient. The separation medium may be in a dehydrated form prior to use in a separation process.

Preferably, the sheet is made from a material which, or carries a coating which, promotes adhesion of the separation medium to the sheet. For example, the sheet may be of the proprietary type Gelbond which carries a coating to which a plyacrylamide gel may covalently bond.

The sheet is ideally sufficiently flexible to be capable of the cooling and sealing functions described below. It should be made from an inert and fluid impermeable material, suitably a synthetic plastics material such as polyester. Preferred sheet thicknesses are in the range 20 to 500 μm, more preferably between 25 and 200 μm, most preferably between 50 and 150 μm.

The area of the relevant sheet face is preferably at least 15 times, more preferably between 20 and 200 times, most preferably between 30 and 100 times, that of the region of contact between the separation medium and the sheet. It is ideally sufficiently large that it may serve at least partly to define the first separation zone and preferably also the second (conveniently acting as a backing for the second dimension separation medium). Suitable dimensions for the sheet are between 100 by 40 mm and 400 by 600 mm.

Supporting a separation medium, such as an IPG strip, on a larger flexible sheet can facilitate handling of the separation medium and its location within the electrophoresis device. Moreover the flexibility of the sheet, and the ability to deform or displace it locally for instance by the application of a pressurised control fluid, may also be used to assist in controlling fluid communication between different zones of the device, particularly around the first separation medium

The application of control fluid pressure to an appropriate region or regions of the flexible sheet (preferably to the face opposite to that carrying the separation medium) may be used to deform and/or displace the sheet in such region(s) and thus to cause it reversibly to contact a sealing component within the device so that the sealing component and sheet together at least partly define an enclosed fluid-tight first chamber containing and/or in contact with at least part of the first separation medium. The thus-defined first separation chamber is preferably of relatively low volume, for instance between 200 μland 2 ml or between 1 times and 4 times the volume of the separation medium after hydration.

The sealing component with which the sheet comes into contact may be for example a gasket, or any other region of the device against which a fluid-tight contact may be made by applying pressure to urge the sheet into contact with that region.

Alternatively, deformation and/or displacement of the sheet may be used to bring the first separation medium itself into contact with a sealing component, the separation medium and the sealing component together at least partly defining a first separation chamber of the type described above.

In an alternative version of the present invention, the function of the barrier means is fulfilled by conducting an electrophoretic analyte separation in the first separation zone in the absence of any separation medium in the second separation zone, and by introducing a separation medium into the second separation zone only when the first separation is complete. The second separation medium may be introduced so as to contact or even surround the first, or more conveniently may be introduced in such a way as to leave a cavity between the first and second separation media which, as described above, may be filled with an appropriate medium such as an agarose gel to allow analytes to move into the second separation medium at the desired time. Features of this cavity, and of the medium introduced into it, may be as for the inter-zone cavity described above.

This version of the invention also allows fluid communication, and analyte migration, between the first and second separation media to be reversibly prevented.

In version of the invention, fluid communication between the first and second separation zones need not necessarily be prevented whilst the first dimension separation is carried out. It is however preferred that the first zone be isolatable from the second during the first dimension separation, for instance using a barrier means of the type described above. Following the first dimension separation, the first and second zones can be brought into fluid communication with one another if necessary, and the second separation medium introduced into the second zone so as to allow migration of analytes from the first to the second separation medium.

The second separation medium may be introduced for instance in the form of an aqueous liquid such as an acrylamide gel precursor, which can subsequently be allowed to set into a slab gel, for example by in situ polymerisation.

Generally speaking the separation medium in the second zone is suitably an aqueous gel, of the type conventionally used for slab gel electrophoresis, such as polyacrylaide. The gel may be polymerised in situ in the device, following introduction of a suitable onomer precursor and polymerisation initiator into the second zone. Typically the gel is between 0.5 and 2 mm thick, preferably between 0.8 and 1.2 mm, more preferably about 1 mm thick.

The first zone preferably contains a separation medium capable of isoelectric focussing of analytes when an electric field is applied across it. This may for instance take the form of an immobilised pH gradient (PG) element, such as a strip or cylinder, which incorporates a pH gradient along one of its dimensions—as described above, this may be carried on a flexible sheet which also functions as the barrier means.

The first zone is preferably of a size suitable to allow at least a degree of fluid movement around an enclosed strip or other element, so that for example a fluid sample may be absorbed by a pre-prepared and pre-dried IPG strip. The zone should include one or more fluid inlets by which a sample, and reagents such as wash fluids, buffer solutions and the like, may be introduced so as to contact and/or immerse the separation medium The zone may be at least partly defined by the barrier means.

The first and second separation zones are preferably adjacent one another, separated only by the barrier means or its associated cavity. However if, as described above, the first dimension separation is carried out in the absence of the second separation medium, the first and second separation zones may in practice be represented by the same physical space, into which the second separation medium may be introduced at an appropriate time so as to be adjacent to or in contact with the first. Suitably the two zones take the form of one or more enclosed, fluid-tight chambers (preferably a first and a second chamber respectively), which can conveniently be provided between two plates. The plates may be made of glass or a similar material such as perspex or polycarbonate, sealed at their edges. Suitable plate separations (chamber depths) are between 0.3 and 5 mm, preferably between 0.5 and 2, more preferably about 1 m.

In a typical device according to the invention, the first separation zone may be between and 500 mm, preferably between 100 and 350, more preferably between 150 and 320 mm, most preferably about 300 mm long (in the direction of analyte movement in use). The second separation zone is typically 50 to 600 mm, preferably between 50 and 400 m, more preferably between 60 and 350 mm, most preferably about 300 mm long in the direction of analyte flow.

Preferably at least a portion of the device of the invention is transparent, or partially so, to a detectable signal indicative of the presence and/or nature and/or quantity of analytes passing through the device. This signal is typically a form of electromagnetic radiation such as from a coloured and/or fluorescent and/or radioactive analyte (which analyte may be labelled by known means to aid its detection). Ideally, the signal is ultraviolet, visible and/or infra-red light, more preferably visible; the separation zones of the device are thus preferably defined at least partly by a transparent glass, perspex or polycarbonate plate.

The electrophoresis device may comprise a third zone/chamber into which a sample may pass on exiting the second zone. This third zone may in particular be a monitoring zone, in which analytes may be viewed as described above, and may have dimensions similar to those of the inter-zone cavity. An additional or alternative zone may provide for collection and/or storage of analytes after processing; such a chamber is typically 50 to 400 mm long in the direction of fluid flow, preferably 100 to 300 mm, more preferably about 200 mm⁻¹ Such a device also preferably comprises barrier means by which fluid communication between the second and third zones, and if necessary between the third and any further zones, may be reversibly prevented. The barrier means may be of the type described above, in this case preferably a removable component.

The device of the invention conveniently comprises one or more fluid inlets, connectable to external fluid sources, by which appropriate fluids may be introduced into the first and/or second and/or third zones and if necessary into any cavity created during use by removable of a barrier means. These may include one or more inlets for introduction of a control fluid so as to operate a deformable or displaceable barrier means.

The device also conveniently comprises one or more fluid outlets, connectable to external fluid sinks, by which fluids may be evacuated from the chambers and/or cavities of the device as necessary.

The device preferably further comprises means for applying an electric field across the first and second separation zones individually. This may comprise electrically conducting elements within the first and second zones, and means for connecting them to an electrical power supply. Ideally, the first zone contains a first pair of electrodes, located one at each end of the axis of analyte separation, and the second zone contains a second pair of electrodes again placed at its upstream and downstream ends. Suitably the first and second electrode pairs are arranged to apply perpendicularly (or substantially so) orientated electric fields, so as to permit analyte separation in two orthogonal or substantially orthogonal dimensions.

Electrodes may suitably be deposited onto plates defining the separation zones.

Preferably, there is a cavity between the or each electrode and the relevant separation medium, into which cavity a fluid may be introduced so as to isolate the electrode electrically from, or connect it electrically with, the other electrode of its pair depending on the conducting properties of the fluid. Each electrically conducting element may thus be spaced from the relevant separation medium by a narrow gap, for instance between 1 and 20 mm wide, preferably between 1 and 10 m, more preferably between 3 and 7 mm, most preferably about 5 mm wide. This gap defines a cavity which may be filled with an electrically conducting fluid (for intance a buffer liquid) so as to allow application of a polarising voltage across the relevant separation medium, but may also be evacuated and/or filled with an electrically resistive fluid so as to inhibit or prevent application of a voltage across the medium. The gap should therefore have associated fluid inlet and outlet means, and its width should be sufficient to allow its filling and evacuation within reasonable timescales when required. It may be defined by a removable component, of a similar type to those which, acting as barrier means, can define inter-zone cavities.

It is particularly preferred that such a cavity be present between the second separation medium and the electrode positioned at its upstream end (ie, the end closest to the first separation medium).

The device of the invention also preferably comprises means for its connection to an external control means by which operation of the barrier means, and optionally of other operable parts of the device, may be controlled.

The device may be used to separate a mixture of analytes such as proteins, peptides, charged polysaccharides, synthetic polymers or any other chemical or biological analytes which are capable of electrophoretic separation, in particular proteins. The sample containing the mixture should be in the form of a fluid, more preferably a liquid such as an aqueous solution or suspension Sample preparation, prior to use of the device, may be conventional.

According to a second aspect of the present invention, there is provided a device component for use as part of an electrophoresis device according to the first aspect, the component comprising first and second chambers suitable for containing first and second separation media, and barrier means by which fluid communication between the first and second chambers may be reversibly prevented.

Such device component may be loaded with suitable separation media (for instance, an IPG strip and/or a polyacrylamide gel) prior to, or at an appropriate point during, use. In particular, its barrier means may comprise a flexible sheet already carrying a first separation medium such as an IPG strip.

The barrier means may otherwise be of the type described above in connection with the first aspect of the invention. Also as above, the device component may be constructed from two plates with the first ad second chambers (and optionally a third chamber) defined between them and with subsequently sealable inlets through which the first and/or second separation media may be introduced. The first and second chambers may be represented by the same physical space, separable into two by the action of the barrier means.

A third aspect of the present invention provides apparatus with which to carry out one or preferably a plurality of two-dimensional electrophoretic separations, the assembly comprising at least one, preferably two or more, more preferably four or six or eight or sixteen or more electrophoresis devices in accordance with the first aspect of the invention or device components according to the second aspect.

Such apparatus preferably also comprises support means for the electrophoresis device(s) or component(s), preferably a separate support means for each. The support means is ideally rigid so as to minimise device movement and disterbance during use. It may incorporate one or more of

(i) fluid connections by which fluid inlet(s) and outlet(s) in the device/component may be connected to fluid sources and/or sinks, such connections optionally including fluid flow control means such as valves;

(ii) electrical connections by which electrically conducting elements in the device/component may be connected to an electrical power supply;

(iii) connections by which the device/component, or parts thereof may be linked to external control means;

(iv) means for regulating the temperature of the device/component or parts thereof, and

(v) sample storage means and sample input means, by which a sample may be pre-loaded into the support means and subsequently introduced into the device/component.

Apparatus in accordance with the invention can allow the simultaneous execution of a plurality of two-dimensional electrophoretic separations. It lends itself particularly well to automation, since the operation of each of its constituent devices may be automated. The apparatus preferably comprises control means such as a microprocessor for operating the devices, preferably individually, and for regulating the supply of fluids, electrical power and the like to them.

The apparatus may additionally comprise one or more sources of fluids useable during an electrophoretic separation; one or more fluid sinks for receiving fluids from an electrophoresis device (optionally with means for recycling spent fluids where appropriate); a source of electrical power, or means connectable to such a source; and means for controlling the temperature of the apparatus or parts thereof.

In particular it may be important to incorporate cooling means into the apparatus, since the application of an electric field to a gel separation medium can cause significant temperature increases. Suitable cooling means include systems for causing movement of a cooling fluid around or within the electrophoresis device(s). Alternatively one or more components of each device (for instance, one of the plates) may be made from or incorporate (e.g., as a laminate) a thermally conductive material such as aluminium, via which heat may be conducted away from the electrophoresis device(s) to a suitable heat sink.

A fourth aspect of the invention provides support means for an electrophoresis device, as described above in connection with the third aspect of the invention and for use in apparatus according to the third aspect. Also provided is an assembly of two or more such support means, optionally together with one or more fluid sources and/or sinks, or at least connections to them, a source of electrical power, operation control means, temperature regulating means and the like. Device components according to the second aspect of the invention, or ready-loaded devices according to the first aspect, may be positioned in such supports in order to carry out an electrophoretic separation.

According to a fifth aspect, the present invention provides a method for separating a mixture of analytes in a sample, the method involving (i) applying the sample to a first separation medium; (ii) applying an electric field across the first separation medium so as to separate the analytes according to a first analyte property and (ii) allowing the sample to migrate from the first separation medium onto a second separation medium under the influence of an applied electric field; and (iv) applying an electric field across the second separation medium so as to separate the analytes according to a second, suitably different, analyte property; wherein migration of the sample from the first to the second separation medium is prevented during step (ii) by a barrier means positioned between the two media but allowed, at the start of step (iii), by the (preferably automatic) removal and/or deformation and/or displacement of the barrier means.

The nature of the first and second separation media, and the nature and operation of the barrier means, may be as described above in connection with the first to fourth aspects of the invention The second separation medium need not be present during the separation carried out on the first medium The method of the fifth aspect preferably involves the use of an electrophoresis device or component according to the first or second aspect and/or apparatus as provided by the third and fourth aspects.

A sixth aspect of the invention provides an alternative method for separating a mixture of analytes in a sample, the method involving (i) applying the sample to a first separation medium in a separation chamber in the absence of any other separation medium; (ii) applying an electric field across the first separation medium so as to separate the analytes according to a first analyte property; (iii) introducing a second separation medium into the separation chamber, adjacent or preferably in contact with the first separation medium; (iv) allowing the sample to migrate from the first separation medium onto the second under the influence of an applied electric field; and (v) applying an electric field across the second separation medium so as to separate the analytes according to a second, suitably different, analyte property. A subsequently removable (for instance at the start of step (iii) or (iv)) barrier means may be used to isolate the first separation medium during steps (i) and/or (ii).

A seventh aspect of the invention provides an electrophoresis device for use in separating a mixture of analytes in a fluid sample, the device comprising a separation zone containing, or suitable for containing, a separation medium through which the analytes may migrate, and electrically conducting elements by means of which an electric field may be applied across a separation medium in the separation zone, the device additionally comprising a cavity between a or each electrically conducting element and the separation medium, into which cavity a fluid may be introduced so as electrically to isolate the conducting element from or connect it with another electrically conducting element depending on the conducting properties of the fluid. Thus, at least one of the electrically conducting elements may be distanced from the separation medium by a narrow cavity into which an electrically conducting fluid may be introduced when electrical contact is required with the at least one conducting element.

This device, which may also accord with the first aspect of the invention, preferably comprises first and second separation zones each containing, or suitable for containing, a separation medium through which analytes may migrate, first electrically conducting elements by means of which an electric field may be applied across a first separation medium in the first separation zone, and second electrically conducting elements by means of which an electric field may be applied across a second separation medium in the second zone, the first and second electrically conducting elements being arranged to allow application of perpendicularly (or substantially so) orientated electric fields so as to permit analyte separation in two orthogonal or substantially orthogonal dimensions across the first and second separation media respectively.

In this arrangement, at least one of the first and second electrically conducting elements is spaced from the relevant separation medium by a cavity. In particular it is preferred that at least one of the second electrically conducting elements (preferably that positioned at the upstream end of the second separation zone in the direction of analyte movement through that zone) be spaced from the second separation medium by a cavity.

As with the device of the first aspect of the invention, the or each cavity may be for instance between 1 and 20 mm wide, preferably between 1 and 10 mm, more preferably between 3 and 7 mm most preferably about 5 mm wide, and ideally has associated fluid inlet and outlet means. It may be defined by a removable barrier component.

The present invention will now be described by way of example only and with reference to the accompanying illustrative drawings.

### BRIEF DESCRIPTION OF THE DRAWINGS

All drawings are schematic.

FIG. 1 is a plan view of an electrophoresis device according to the invention;

FIG. 2 is a perspective view, from above and one side, of part of the FIG. 1 device;

FIG. 3 is a perspective view of part of a barrier strip for use in the FIG. 1 device;

FIG. 4 is a plan view of part of the FIG. 1 device, showing the typical movement of a fluid sample through the device;

FIGS. 5 and 6 are sections through part of an alternative electrophoresis device according to the invention, the two figures illustrating different positions of a displaceable barrier means in the device;

FIGS. 7 and 8 are plan views of parts of the device shown in FIGS. 5 and 6;

FIGS. 9 and 10 are plan views of parts of electrophoretic separation devices, the first according to the prior art and the second according to the present invention, illustrating the application of an electric field across the devices;

FIGS. 11-13 illustrate parts of apparatus according to the third aspect of the invention, each comprising several electrophoresis devices such as are shown in FIGS. 1-6; FIG. 14 is a section through the sealing element of the device shown in FIGS. 5 and 6;

FIG. 15 is a longitudinal section through an alternative electrophoresis device according to the invention;

FIGS. 16A, 16B and 16C are more detailed sections through parts of the FIG. 15 device, showing different stages in its operation;

FIG. 17 is a section through part of a device according to the invention, showing an alternative electrode arrangement;

FIG. 18 is a section through part of another device according to the invention, showing an alternative electrode arrangement;

FIG. 19 is a section through part of an alternative electrophoresis device according to the invention;

FIG. 20 is a part section along the line VI-VI in FIG. 19; and

FIG. 21 is a section through part of another device according to the invention.

### DETAILED DESCRIPTION

The following relates to electrophoretic separations in which the first dimension separation is effected by means of an IPG strip and the second on a slab gel, with the application of orthogonal electric fields across the first and second separation zones. Other electrophoretic separation techniques may be combined when using the method and apparatus of the present invention.

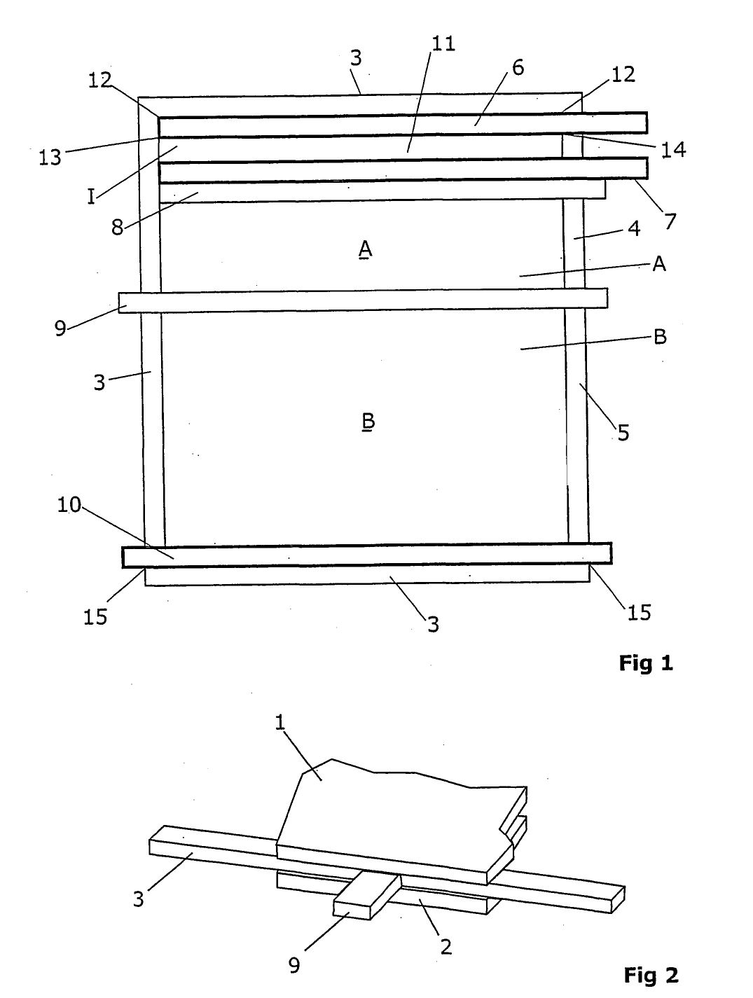

FIGS. 1 and 2 show an electrophoresis device in the form of a “cassette” which comprises two glass plates 1 and 2 (see FIG. 2) separated by a series of sealing strips 3-5 and “blanking” or barrier strips 10. The sealing and barrier strips are typically made from rubber although other elastomeric materials may be suitable.

The glass plates, the sealing strips and the barrier strips together define three adjacent chambers labelled I, A and B in FIG. 1.

The cassette is shown pre-loaded ready for use. The chamber I encloses an IPG gel strip 11; chambers A (separation) and B (collection) each enclose a 10-15% w/v polyacrylamide gel.

The cassette also incorporates electrode wires 12-15, typically platinum or platinum plated.

The FIG. 1 cassette may be assembled as follows. The sealing strip 3 (note: not the separate strips 4 and 5) is affixed around the periphery of one of the plates 1,2. Electrode wires 12-15 are appropriately positioned and may be trapped under the sealing strip during this process. The barrier strips 6-10 and the IPG strip 11 are laid in the desired positions and the second plate is laid on top and affixed to the top of the sealing strip.

The sealing strip 3 may itself be constructed from a number of separate lengths of a suitable sealing material, to allow for the barrier strips to be positioned as shown.

The gels in chambers A and B are now prepared by pouring a suitable gel precursor (for instance, a casting mixture containing an acrylamide monomer, a polymerisation initiator and water) into the two chambers through the apertures left by omission of the sealing strips 4 and 5. Strips 4 and 5 are then inserted before polymerisation is complete to create a seal between the gels and the sealing strips.

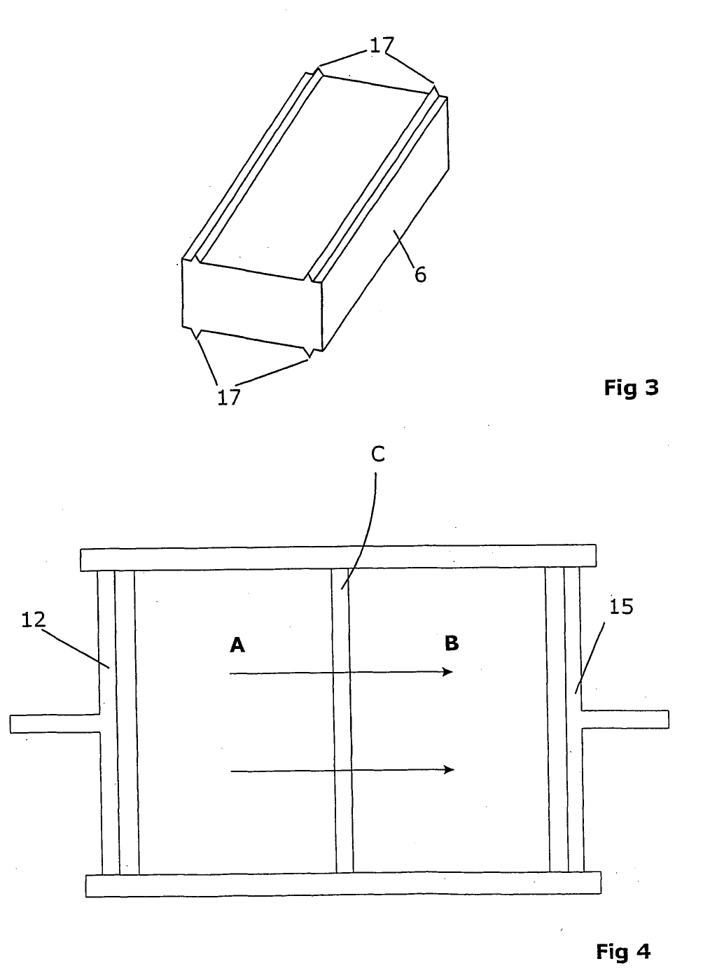

For a more effective seal between the barrier strips and the glass plates, the former may carry profiling such as one or more ridges (as 17 in the strip 6 illustrated in FIG. 3), so as to concentrate a moderate clamping force into a high-pressure contact in the profiled region(s).

A clamping force is preferably applied to the two plates to ensure effective edge sealing. This may be provided for instance by adhesive applied to the mating faces of the edge sealing strips and the plates, or by externally applied edge clamps (not shown). In the latter case, the sealing strips 3, 4 and 5 may also be profiled in the manner described in connection with FIG. 3.

The FIG. 1 cassette may be used to carry out one- or two-dimensional gel electrophoresis in conventional fashion. However the FIG. 1 cassette differs from conventional electrophoresis devices in the ability selectively to block or (by removal of the barrier strips 7 and 8) to open a cavity between the IPG chamber I and the separation gel chamber A. This allows the user to control the progress of a two-dimensional separation whilst ensuring an efficient transfer of sample from the first to the second dimension.

Selective opening of cavities between the chambers I, A and B is achieved in the FIG. 1 apparatus by withdrawal of appropriate barrier strips 7-9. To aid withdrawal, at least one end of each barrier strip should extend beyond the edge of the plates 1,2 and the relevant sealing strip (as shown in FIGS. 1 and 2). The barrier strips may be removed manually, but ideally their removal is mechanised and automated, for instance under the control of a microprocessor.

A cavity created by removal of a barrier strip is then supplied with an appropriate medium (preferably fluid, although not necessarily), allowing movement of analytes across the cavity from one chamber to the next, for instance under the influence of an applied electric field.

Whilst it is common practice to run one- or two-dimensional gels with a fluid sample entering the gel in one region, passing through the gel under the influence of an applied electric field and then optionally exiting the gel near to the downstream polarising electrode, the present invention allows a sample to exit a first gel zone and pass immediately into a second gel zone, via a narrow fluid-filled cavity. FIG. 4 illustrates, for example, how a sample may progress from the gel separation zone in chamber A of the FIG. 1 cassette to the gel collection zone in chamber B, via a narrow cavity C which is created by removal of barrier strip 9. The polarising electric field may be applied across both zones by means of the electrodes 12 and 15.

To run a two-dimensional separation using the FIG. 1 cassette, barrier strips 6 and 7 are firstly removed to create cavities both upstream and downstream of the IPG strip 11. (Barrier strip 9 may also be removed at this stage.) A sample fluid, containing a mixture of analytes to be separated, can be introduced into either or both of these cavities to flow around the IPG strip. It is important that the sample soaks into the strip and not into the gel in chamber A, so the barrier strip 8 is ideally left in place until the first dimension electrophoresis (and any associated wash processes) have been completed.

A potential difference is then applied along the IPG strip by means of electrodes 13 and 14, causing the analytes to migrate along the strip to effect a first dimension separation.

Once the first separation is complete, barrier strip 8 is removed to create a cavity between the chambers I and A. This cavity is filled with a suitable fluid, such as a buffer solution, to allow charged species in the sample to migrate from the IPG strip into the second dimension gel separation zone A. Again an electric field is applied across the gel, this time in a direction perpendicular to that of the field applied along the IPG strip, by means of electrodes 12 and 15.

Barrier strip 9 is also removed, either before or after removal of strip 8, to create a narrow transparent cavity C (as seen in FIG. 4) between gel zones A and B. Cavity C is also filled with fluid, and the electric field applied via electrodes 12 and 15 causes movement of charged analytes through the gel separation zone A, the cavity C and the gel collection zone B, in the direction of the arrows in FIG. 4.

Provided the inter-chamber cavities (such as C) are sufficiently narrow and fluid flow within them is small, then the analyte separations in the direction longitudinal to the IPG strip will be maintained as they traverse each cavity. Thus, two adjacent electrophoresis gel zones may be separated by a narrow fluid-filled gap without disturbing the operation of the zones as two-dimensional separation media. Fluid flow within the cavities may be minimised using appropriately positioned flow control valves, and/or by using a suitably viscous buffer medium Alternatively, the cavities may be filled with a liquid which subsequently sets to a gel, for instance hot agarose.

The barrier strips are preferably removed automatically, such as by automated mechanical means. Alternatively, the barrier strips may be made of a material whose physical and/or chemical properties can be altered, so as td allow analyte movement, under certain applied conditions such as an elevated temperature. For instance, the strips may be made of a solid and relatively fluid impermeable substance that either melts or becomes permeable at an elevated temperature (agarose gel, for example). Adjacent chambers may thus be isolated from one another until an appropriate time, when the temperature of the cassette may be raised (either overall, or locally to the relevant barrier strip(s)) to allow sample movement between the chambers.

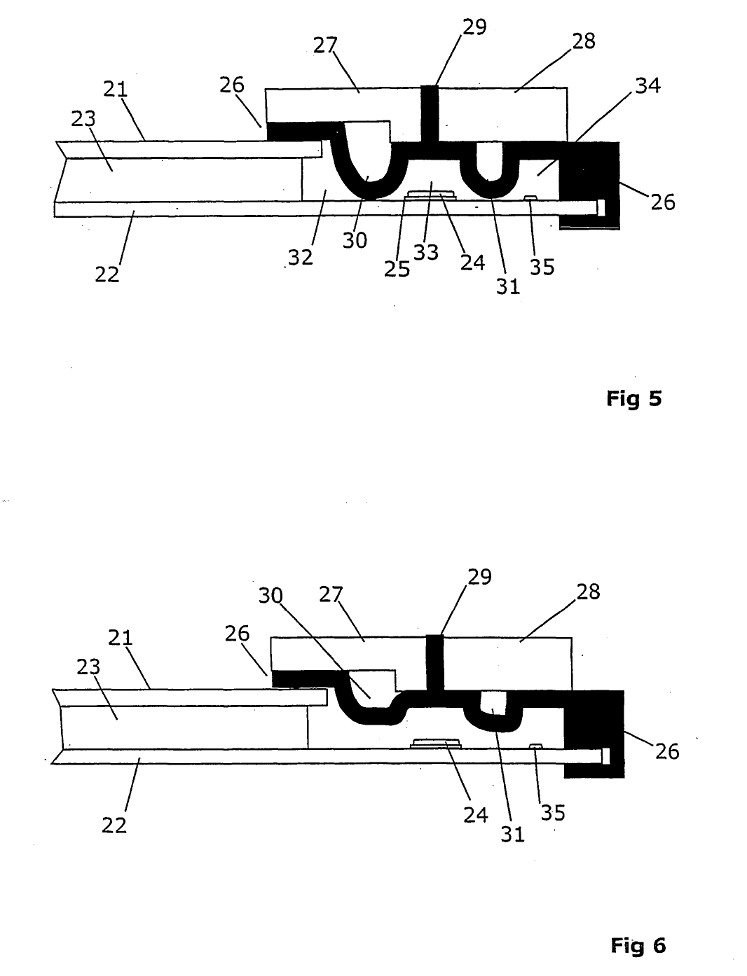

Alternatively the cassette may, for instance in the region of the IPG strip 11, have the preferred form shown in schematic cross section in FIGS. 5 and 6, in which a flexible sealing element can be displaced between two positions so as selectively to allow or inhibit sample movement between two adjacent cassette zones.

In FIG. 5, glass plates 21 and 22 enclose a gel 23 suitable for a second dimension electrophoretic separation. The “lower” (as seen in FIG. 5) plate 22 extends beyond the end of the “upper” plate 21. An IPG strip 24 is deposited onto the extended portion of plate 22 by any convenient technique and may be sealed with a self-adhesive plastic strip to protect it during subsequent processing and storage. Preferably the IPG strip is dried (dehydrated) prior to sealing to reduce degradation in storage and so that it will absorb a liquid sample more rapidly during use. To help localise the sample during absorption, it is preferable to deposit a hydrophobic coating layer 25 onto the plate 22 beneath the IPG strip. The hydrophobic coating covers an area wider than the IPG strip and repels aqueous liquid spilling off the strip.

It is preferable to position the cassette horizontally with plate 22 as the lower plate (as in FIG. 5) whilst a liquid sample is being absorbed.

During use of the FIG. 5 cassette, any sealing film over the IPG strip is removed and a flexible sealing element 26 is clamped over the region around the strip. The sealing element 26 should be made of an inert, fluid impermeable, flexible material, suitably silicone rubber or another inert elastomer. Typical dimensions for it are shown in FIG. 14. It may be held in place against plate 21 by a clamp 27 and against plate 22 by clamp 28, the two clamps acting against each other through the upstanding portion 29 of the sealing element. The clamped sealing element 26 defines, together with the clamps 27 and 28, two “control chambers” 30 and 31. Fluid conduits (not shown) are provided through clamps 27 and 28 to allow the introduction of a control fluid independently into either or both of the chambers 30 and 31.

The sealing element 26 also defines, with the plates 21 and 22, three separate sample fluid chambers 32, 33 and 34, of which 32 communicates with the second dimension separation zone containing gel 23.

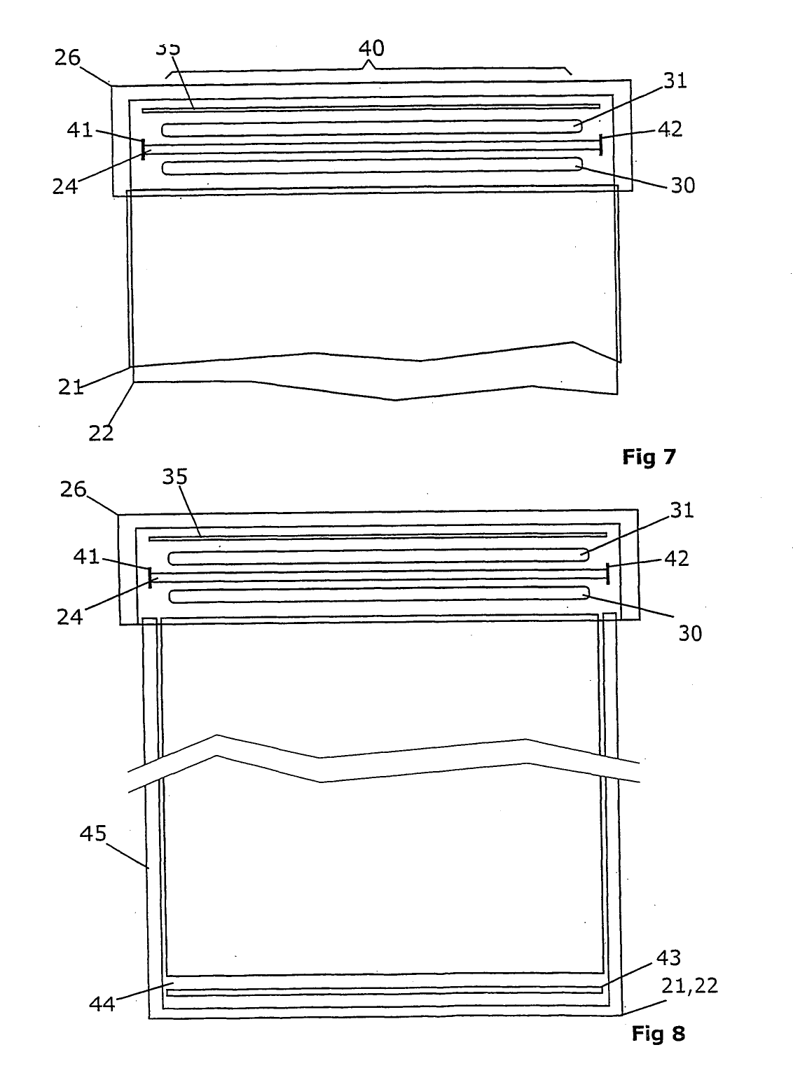

Also shown in FIG. 5 is an electrode 35, use of which is described below in connection with FIGS. 7 and 8.

The sealing element 26 is constructed so that in the absence of pressure in the control chambers 30 and 31, it does not contact the plate 22 in these regions. This case is illustrated in FIG. 6, which otherwise corresponds to FIG. 5. Chambers 32, 33 and 34 now communicate to form a single enclosed volume, and sample analytes may pass from the region of the IPG strip into the second dimension separation gel. The sealing element can be pressurised via either or both of the control chambers (as in FIG. 5) so as to, prevent sample movement both upstream and downstream of the IPG strip independently. Pressurisation can suitably be achieved by supplying a control fluid, such as pressurised air, to the control chamber(s).

The above mechanism for allowing or inhibiting fluid communication between the first and second dimension separation zones, which lends itself well to automation, may also be used to control sample and/or fluid movement between other regions of the cassette.

FIGS. 7 and 8 show in schematic plan view parts of the cassette illustrated in FIGS. 5 and 6. The clamps 27 and 28 are omitted for clarity. The control chambers 30 and 31 can be seen, partly defined by the sealing element 26, as can the IPG strip 24, the electrode 35, and the cassette plates 21 and 22. When the control chambers are unpressurised, the chambers 32, 33 and 34 communicate with one another only across the width indicated as 40. Beyond this, the sealing element 26 is clamped against the plate 22.

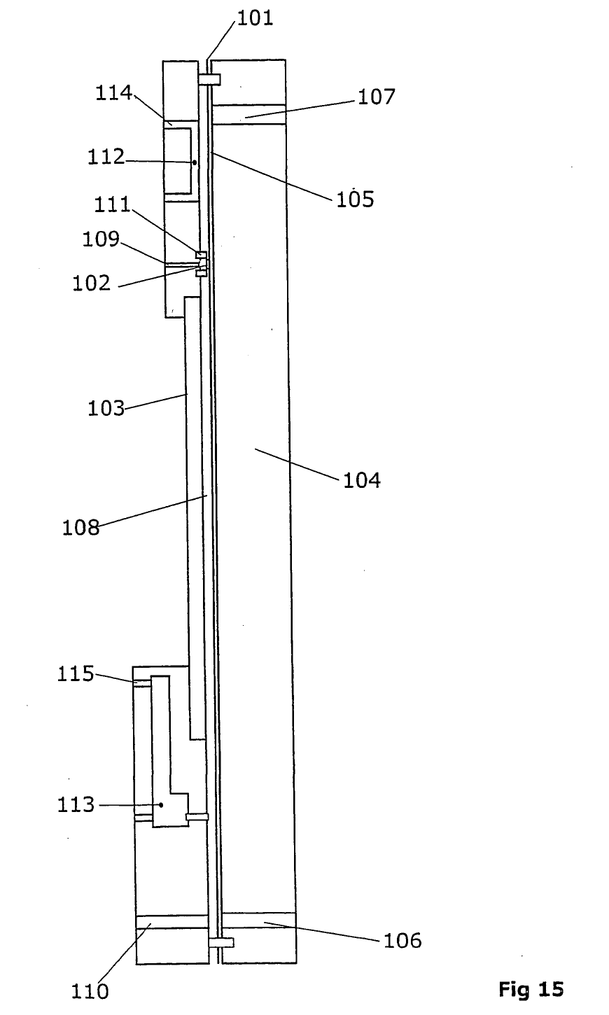

An analogous function can be achieved by using a flexible sheet as in the device of FIG. 15, which also carries an IPG strip as the first separation medium.

FIGS. 7 and 8 also show electrodes 41 and 42, corresponding to electrodes 13 and 14 respectively in the FIG. 1 apparatus. These, lice the electrodes 35 and (see FIG. 8) 43, are deposited onto the plate 22 and are suitably made from graphite or silver powder within a resin binder, applied for instance by screen printing, a technique well known in the field of membrane switch manufacture. The printed form of the electrodes brings electrical connections (not show) to the edges of plate 22 where they can be connected by any convenient means to an electrical power supply. The electrodes 35, 41, 42 and 43 are preferably deposited on the plate 22 prior to deposition of the IPG strip.

The electrodes allow the application of polarising voltages either longitudinally with respect to the IPG strip 24 (through electrodes 41 and 42) or transversely using electrodes 35 and 43.

Fluid conduits (not shown) are provided through both ends of the sealing element 26 to allow fluids (for instance, sample fluid, buffer solution or wash fluids) to be introduced into and evacuated from the chambers 32, 33 and 34. Preferably each chamber has a fluid inlet at one end and a fluid outlet at its opposite end.

FIG. 8 also shows how a cavity 44 is formed between the plates 21 and 22 immediately downstream of the gel. It also shows how exposed edges of the gel zone and the cavity 44 are sealed by perimeter sealing strip 45. Again, fluid conduits (not shown) are provided through the sealing strip 45 at either end of the cavity 44 to allow the introduction of fluid (e.g., buffer solution) into the cavity and its subsequent removal.

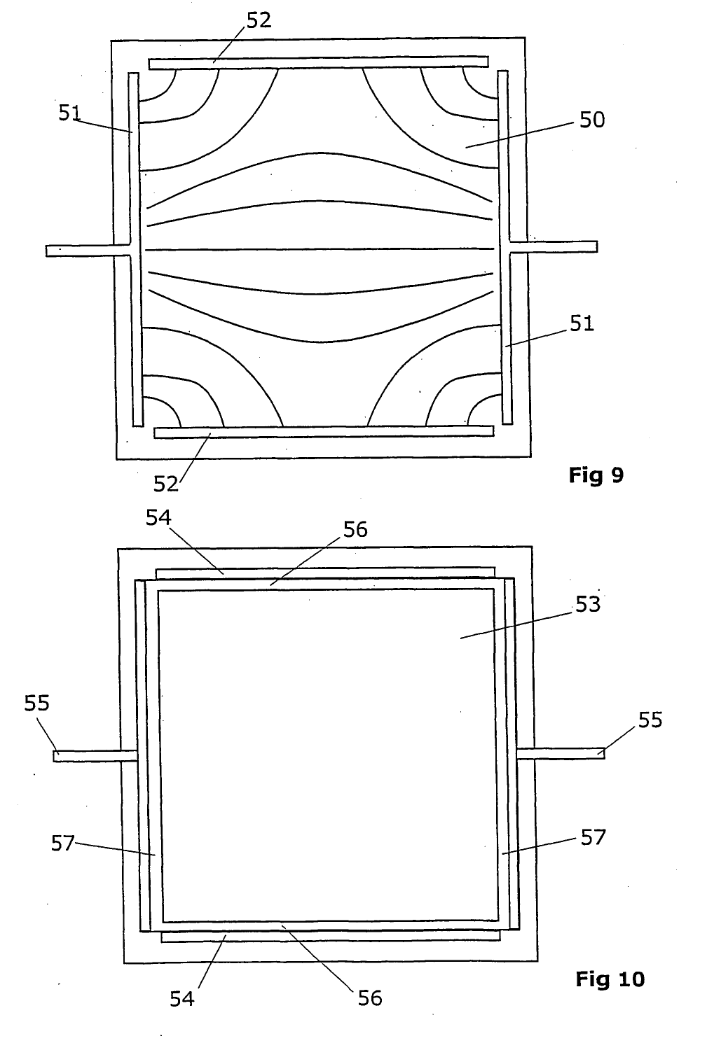

The FIGS. 1 and 5 cassettes also allow selective application of polarising electric fields, coupled through buffer fluid, in a way that can enhance field uniformity. In conventional gel electrophoresis, an electric field is normally applied to a liquid system via electrodes in contact with the liquid. This can cause problems when fields have to be generated across a gel in orthogonal directions. A voltage is applied across one pair of electrodes with the aim of producing a uniform electric field between the, but the conductivity of the second, orthogonal, electrode pair distorts the field from the first pair at the edges and corners of the gel. This is illustrated in FIG. 9, which shows in schematic form a conventional gel 50 with two orthogonal electrode pairs 51 and 52 in contact with the gel and with the fluids moving through it.

In the FIG. 1 and FIG. 5 cassettes, in contrast, electric fields my be applied as illustrated in FIG. 10. Here a gel 53 can be seen to be separated from the two orthogonal electrode pairs 54 and 55 by narrow spaces 56 and 57 respectively. These spaces can be filled with buffer solution in order to apply an electric field across the gel between the relevant electrode pair, but when empty, the spaces isolate the gel from the electrodes. For instance, when the spaces 56 are empty, the gel is electrically isolated from the electrode pair 54. When the spaces 56 are filled with an electrically conductive fluid such as a buffer solution, an electric field may be applied across the gel between the electrodes 54.

Thus, filling the spaces 56 with buffer solution while keeping spaces 57 empty allows application of a uniform electric field between the electrodes 54. An orthogonal field can similarly be applied between electrodes 55 when the spaces 57 contain an electrically conducting fluid.

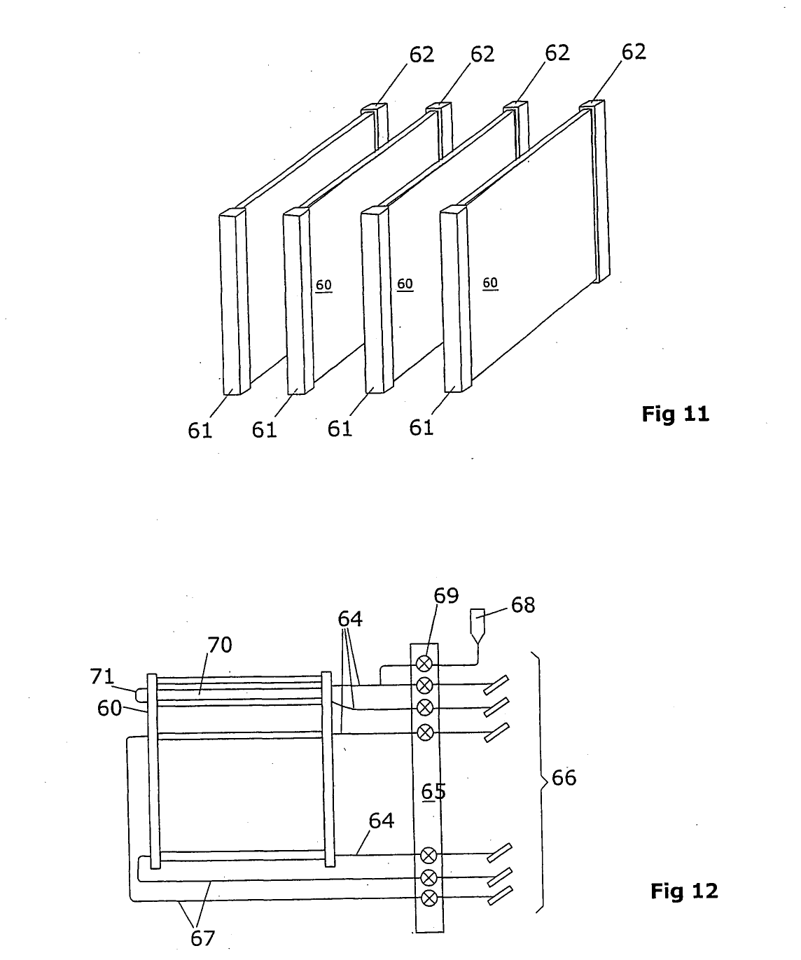

Apparatus in accordance with the third aspect of the present invention, which comprises a plurality of cassettes such as those of FIG. 1 or FIG. 5, is shown schematically in FIG. 11. It allows the simultaneous processing of more than one cassette, ideally under the automatic control of a microprocessor. The cassette construction lends itself particularly well to automation of an electrophoretic separation being carried out in it.

The FIG. 11 assembly comprises in this case four gel cassettes 60. Apparatus in accordance with the invention may of course include more or fewer such cassettes, according to requirements; an alternative assembly might typically include six cassettes, for example.

Each cassette fits into and is supported by two cassette holders 61 and 62. The holders contain fluid conduits to allow fluid connections between the cassette they support and external fluid sources and/or sinks. Supply of fluids to the cassettes may be achieved in any desired manner, typically via suitable fluid conduits, pumps, valves and the like. It may in particular be achieved via a fluid supply manifold which distributes fluids from one or more external reservoirs or similar sources to the appropriate cassette(s) at appropriate times. Such distribution is preferably automatically controlled, for instance via a programmable microprocessor. Similar comments apply to the removal of fluids from cassette(s), typically to a waste sink and again suitably via a fluid removal manifold which, like the fluid supply manifold, ideally serves more than one, preferably all, cassettes in the assembly.

The fluids typically supplied to the gel cassettes 60 might include liquid reagents and wash solutions such as wash detergent, wash water and an appropriate running buffer. They may also include air or another inert gas with which cassettes may be flushed in order to empty and/or dry them.

A fluid input device may be associated with the supply manifold. A suitable input device might be for example an electrically operated syringe that can both aspirate fluid from a source ad dispense it to the manifold. This can allow accurately controlled volumes of fluids to be delivered to or removed from the cassettes. By aspiration of a controlled volume of a “buffer” fluid (including an air gap) prior to aspiration of a second fluid such as a reagent or sample, delivery of the second fluid to a predetermined location within the system is possible.

Further, by reciprocating the fluid input device between its aspiration and dispense modes, a fluid can be washed back and forth through a desired part of the system.

Typically, fluids will be introduced into a cassette chamber or cavity at one of its ends and removed from, the opposite end. In particular, in say the FIG. 1 cassette, fluids need to be supplied to and removed from the first dimension chamber (I) and ideally also the second dimension chamber (A and/or B), the cavities created when the barrier strips 6, 8 and 9 are removed and the cavities between gels and electrodes.

Fluids may be pumped from their sources to the cassettes either by applying a positive gauge pressure to the sources and venting fluid sinks to ambient pressure, or by applying a negative gauge pressure to the sinks and venting the sources to ambient pressure. The latter method may be preferred because maintaining the system at a lower than ambient pressure (a) helps prevent unwanted flooding of system parts should leaks occur and (b) increases the clamping of the cassette plates onto their perimeter seals, so improving fluid sealing. In contrast, a higher than ambient pressure in the assembly may tend to force the plates away from the seals and thus impair sealing.

FIG. 12 shows how a cassette 60 may be connected to fluid manifolds in apparatus such as that of FIG. 11. Fluid inlets in the cassette are connected, via inlet conduits 64 and a valve assembly 65, to sources of appropriate fluids via fluid distribution manifolds, generally labelled 66, which are common to several or all cassettes in the assembly. Similarly, fluid outlet conduits 67 carry fluids from the cassette, again via the valve assembly 65, to common fluid manifolds and thence to waste.

FIG. 12 also shows a sample reservoir 68 and an associated valve 69, by which a sample containing analytes to be separated may be introduced into the first dimension zone of the cassette. Typically, each cassette will have its own associated sample reservoir connected via a dedicated valve or other fluid input device in the valve assembly 65. This allows a small quantity of sample to be supplied to the cassette with little dead volume or waste. The sample fluid source need only be connected to the first dimension chamber of the cassette.

If the cassettes in the assembly are of the type shown in FIGS. 5 and 6, then the fluid distribution system also needs to supply a control fluid, such as pressurised air, to the control chambers 30 and 31 of each cassette.

Each cassette in the FIG. 11 assembly has its own associated valve assembly such as 65 in FIG. 12, which is conveniently provided as part of the cassette holders 61 and/or 62 or as a component connectable to the holder(s). The valve assembly in turn communicates with the fluid distribution manifolds 66.

The cassette shown in FIG. 12 contains in its first separation zone an IPG strip 70. The cavities either side of the IPG strip interconnect at one end via conduit 71, as shown. This allows a small quantity of fluid to be circulated along one cavity then back through the other with little dead volume. In an alternative version of the cassette, a small gap could be provided in the IPG strip at one end, to allow fluid flow along one side of the strip, through the gap, then back along the other side.

Preferably the supply of fluids to, and evacuation of fluids from, the cassettes is controlled automatically by means of a programmable microprocessor or other analogous control means. This may control all fluid valves, pumps, input devices and the like, to ensure that the correct fluids pass through each cassette at the correct times.

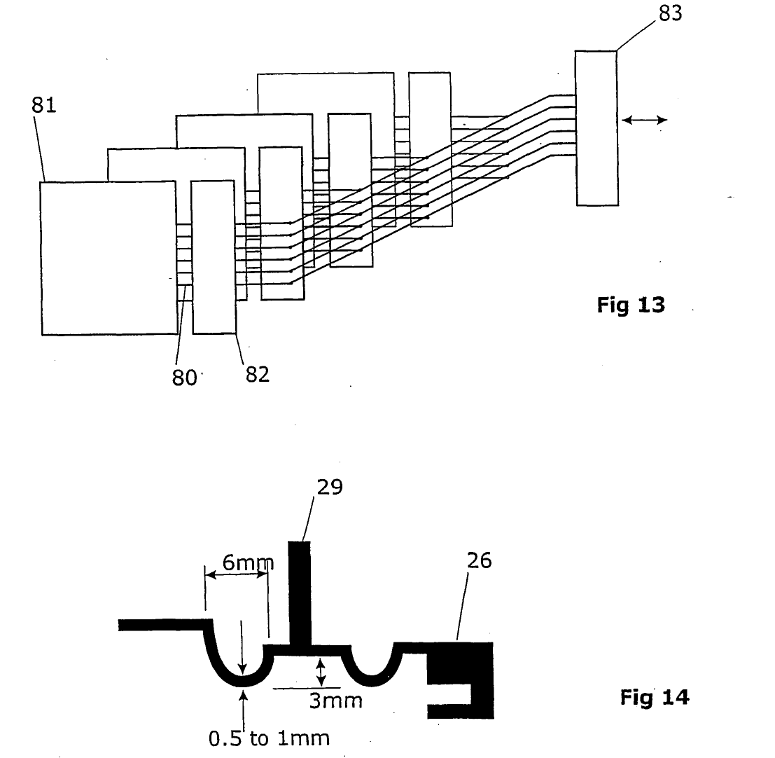

In the apparatus shown schematically in FIG. 13, fluid connections 80 can be seen between each of four gel cassettes 81, via their respective cassette valve assemblies 82 and a common source/sink valve assembly 83 associated with the necessary fluid source(s) or sink(s) (not shown).

Control of the whole of the FIG. 11 or 13 assemblies is ideally automated. This should include co-ordination of fluid flows through and polarising voltages applied to the cassettes, whether individually or together. The control system may also control other systems associated with the cassettes, such as heating and/or cooling means.

Apparatus in accordance with the present invention may comprise one or more cassette holders and their associated fluid distribution systems, into which a user can insert one or more cassettes prior to use. Conveniently each cassette can be “plugged into” a pair of holders such as 61 and 62 in FIG. 11, once the necessary barrier strip(s) have been withdrawn Fluid ports provided in the cassette holders mate with apertures in the cassette perimeter seals to allow fluid communication between the chambers and cavities in the cassette and the fluid handling components of the rest of the assembly.

A typical method of operating the FIG. 11 assembly will now be outlined, firstly for the case where the gel cassettes are of the type shown in FIG. 1, and secondly for the case where they are of the type shown in FIG. 5. Although operations on only one cassette are described, processing of more than one cassette involves the same general principles but scheduled according to individual use of common resources (e.g., fluid sources and sinks and electrical supplies).

Naturally, prior to use of the assembly, samples containing target analytes must be suitably prepared, as for a conventional electrophoretic separation.

Version 1—Using Extractable Barrier Strips FIG. 1 Cassette)

Here the operating sequence is outlined for (i) the fluid distribution system and (ii) the electrical parts of the system. Reference numerals relate to the parts of the FIG. 1 cassette.

| (i) Fluid action | (ii) Polarising potential |
|---|---|
| Flush all manifolds | None |
| with detergent and water | |
| Empty all the cassette | None |
| chambers and cavities | |
| Flush the cavities corresponding | None |
| to barrier strips 9 and 10 with | |
| 2-D running buffer | |
| Condition (dry out) the IPG | None |
| strip 11 by flowing dry gas | |
| through cavities 6 and 7 for | |
| an extended period | |
| Using a syringe, wash the sample | None |
| from the sample reservoir back and | |
| forth through cavities 6 and 7. The | |
| fluid soaks into the dried IPG strip. | |
| Then purge any remaining fluid by gas | |
| flow | |
| None | Apply across electrodes 13 |
| | and 15 according to |
| | conventional 1-D practice |
| Wash denaturing solution and | None |
| SDS buffer through cavities 6 | |
| and 7, then purge with gas | |
| Wash 2-D running buffer through | None |
| cavities 6, 7, 8, 9 and 10, | |
| leaving all filled | |
| Leave buffer solutions stationary | Apply across electrodes 12 |
| in cavities 6, 7, 8 and 9. Maintain | and 16 according to |
| a continuous flow of buffer | conventional 2-D practice |
| through cavity 10 (this may be | |
| recirculated to a dedicated bottle | |
| reserved for the purpose). Flow | |
| through cavity 10 is important | |
| for removal of, bubbles created | |
| by electrolysis | |

Version 2—Using Deformable Sealing Element (FIG. 5 Cassette)

Here, reference numerals relate to parts of the FIG. 5 cassette.

A typical operating sequence would be:

1 Remove the self-adhesive protection strip from the IPG strip 24.

2 Dispense the sample (e.g., a mixture of proteins) as a liquid onto the IPG strip and hold the cassette horizontally while the strip absorbs the liquid.

3 Clamp the sealing element 26 onto the cassette, covering the region of the IPG strip.

4 Make fluid and electrical connections to the cassette.

5 “Inflate” (Le., pressurise) control chambers 30 and 31 to isolate the IPG strip.

6 Apply a longitudinal polarising voltage to the strip and wait for the analytes to focus to their isoelectric positions.

7 Flow denaturing solution and SDS over the IPG strip via chamber 33.

8 Wash out chamber 33 and the IPG strip.

9 “eflate” (ie., depressurise) control chamber 30.

10 Flow hot agarose through the communicating chambers 32 and 33 and allow to cool and set to a gel.

11 Deflate control chamber 31.

12 Flow buffer solution through chambers 34 (running against the top edge of the agarose) and 44 (running against the bottom edge of the second dimension gel region 23).

13 Apply a polarising voltage transverse to the IPG strip via electrodes 35 and 43, causing analytes in the IPG strip to move into the second dimension gel.

For both versions of the operating method, typical buffer fluids might be, for example:

a) for sample disruption/solubilisation—9.5M urea (or 7M urea with 2M thiourea), 2% w/v CHAPS, 2% v/v Pharmalyte™ pH 3-10 (Amersham Pharmcia Biotech Ltd), 1% w/v dithiothieitol and 5 mM Pefabloc™ protease inhibitor (Merck). (The nature of this buffer naturally depends on the nature of the sample.)

b) for the first dimension separation—the gel is rehydrated using the sample in the sample disruption buffer.

c) for the second dimension separation—a running buffer of 200 mM glycine, 25 mM Tris buffer pH 8.8 and 0.4% w/v SDS.

The electrophoresis devices shown in FIGS. 15 to 21 may be used to conduct either a single dimension or, more preferably, a two dimensional separation.

The FIG. 15 device comprises a 80 μm thick flexible polyester sheet 101 on which a gel. IPG strip 102 has been formed. This is secured in place between front and back support plates labelled 103, 104 respectively. Between the sheet 101 and the back plate 104 a narrow rear chamber 105 allows for the supply of cooling fluid to the rear face of the sheet, the fluid (eg, water) being introduced through inlet 106 and evacuated through outlet 107.

The other face of the sheet 101 serves partly to define a front chamber 108, which fluids may be introduced into or evacuated from via the conduits 109, 110. In the region of the IPG strip 102, a sealing gasket 111 is provided on the front plate 103.

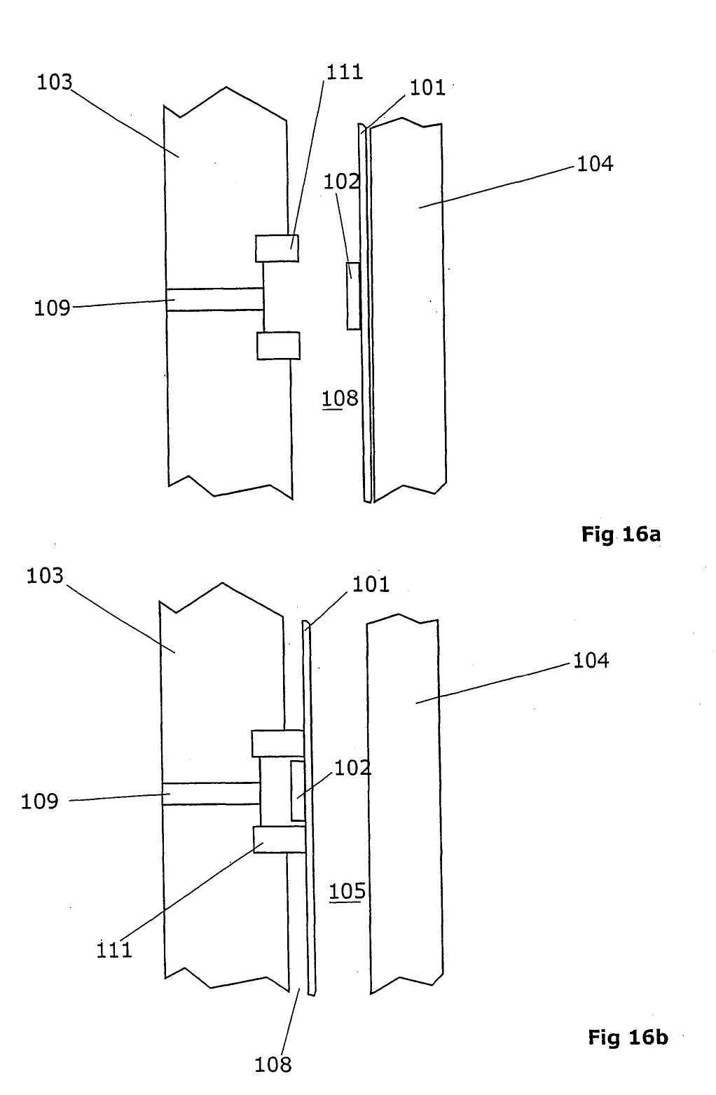

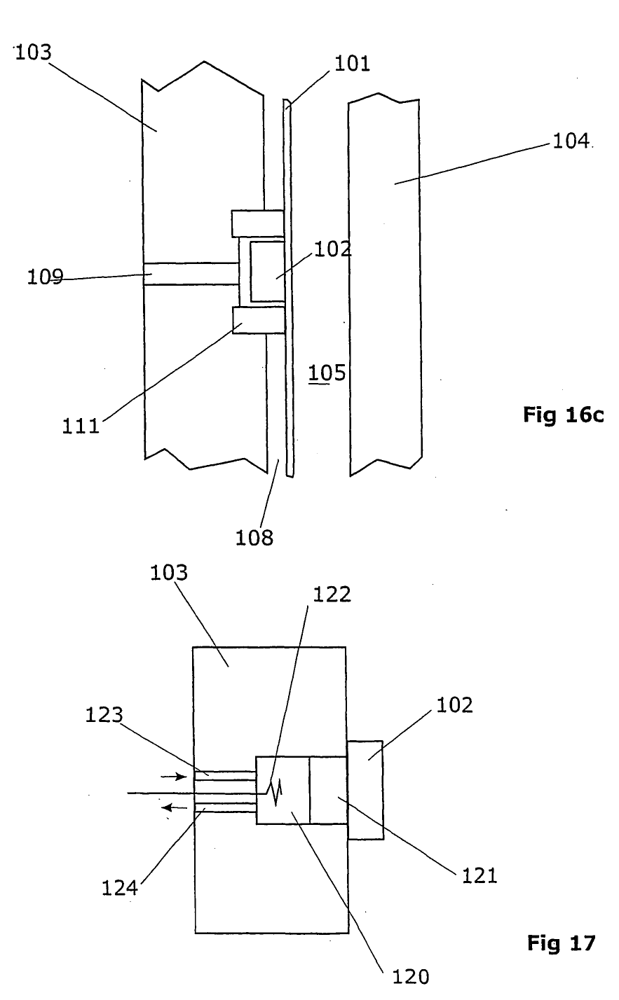

The rear chamber 105 functions as a control chamber and the cooling fluid as a control fluid. When the pressure in the rear chamber is relatively low, as shown in FIG. 16A, the IPG strip is not in contact with the gasket 111. By applying a positive fluid pressure in the rear chamber 105, the sheet 101 can be urged into contact with the gasket 111, thus defining a low volume enclosed chamber around the IPG strip (see FIG. 16B). Sample and/or reagent fluids (including, for instance, imaging agents such as stains) may be introduced into this chamber (the first separation zone) via the conduit 109, causing the dehydrated IPG strip to swell (FIG. 16C). An electrophoretic separation may be carried out on the IPG strip in a protected and controlled micro-environment. Efficient cooling of the strip, during the separation, is easily achieved via the rear chamber 105.

To perform a first dimension separation it is necessary to apply an electric field along the length of the IPG strip. This is conventionally done using electrodes at either end and applying a high voltage between the. In the FIG. 15 device, items 112, 113 are such electrode wires and extend across the device parallel to the longitudinal axis of the IPG strip. Conduits 114, 115 allow the supply of buffer liquids to the two electrodes, in conventional fashion but preferably being continuously replenished from reservoirs (not shown).

To avoid contamination with metal ions, platinum wire is normally used for the electrodes. When the voltage is applied, some constituents of the hydrated strip arrive at the electrodes. To avoid them interfering with the remainder of the strip it is known to include a damp absorbant wick (usually paper) between the electrode and the strip. One method of achieving the same function is shown in FIG. 17, in which parts analogous to those shown in FIGS. 15 and 16 have been given the same reference numerals.

At positions corresponding to the two ends of the IPG strip 102, cylindrical cavities 120 (typical cross sectional diameter 2.5 mm) are provided in plate 103. In each of these cavities is incorporated a porous plug 121, preferably made of paper. Below the plug is an electrode wire 122, for example platinum, and two ports 123, 124 for entry and exit of electrode buffer liquid. Preferably, the liquid is drawn by vacuum from a reservoir by a pump. This helps prevent flooding of the strip by excess buffer liquid.

The liquid fills the remainder of the cavity 120 and soaks into the IPG strip. In doing so, it makes an electrical path from the electrode 122 to the porous plug 121 and so to the IPG gel that is in contact with the plug. The buffer liquid not only provides the electrical contact but also helps maintain pH at the end of the strip. The electrode at the acid end of the strip could use phosphoric acid of 0.001 to 0.5 M, preferably 0.005 to 0.02 M. The electrode at the basic end could use sodium hydroxide of a similar molarity.

Preferably the buffer liquids are made to flow slowly as electrophoresis progresses. This flow helps to remove bubbles of gas generated at the electrodes and flushes away species that have migrated to the electrodes. Preferably, the buffer flow rate is 0.1 to 10 ml/min.

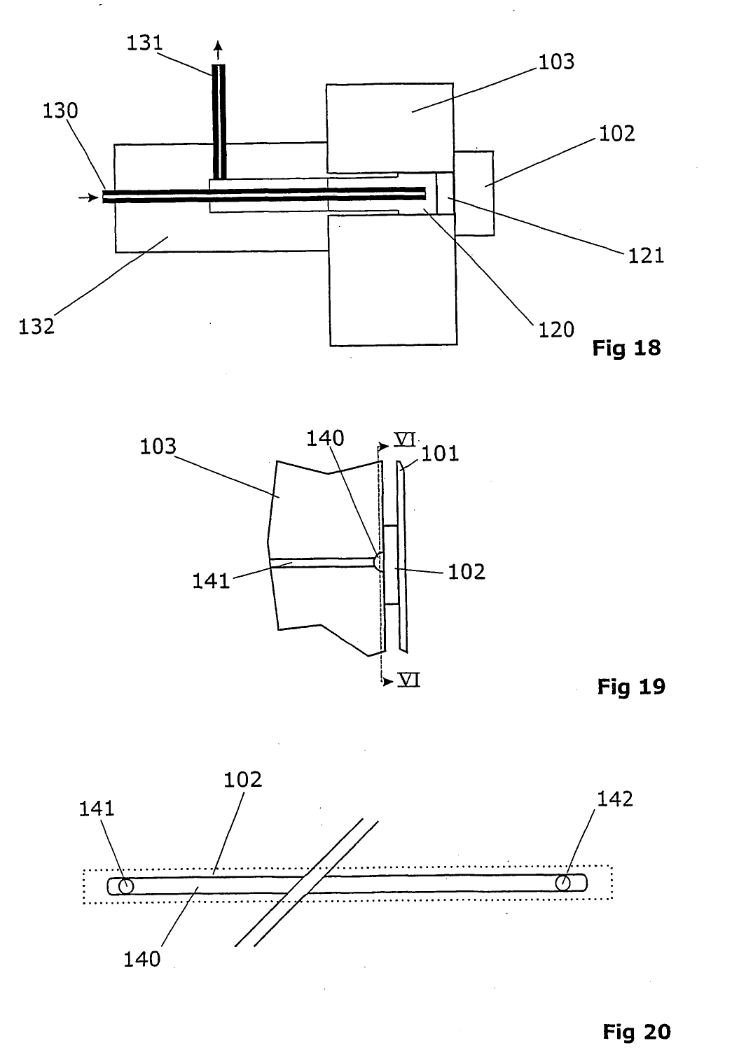

An alternative form of electrode arrangement is shown in FIG. 18. Again, parts analogous to those in FIGS. 15, 16 and 17 have been labelled with the same reference numerals.

In the FIG. 18 arrangement, the electrode wire is integrated with one or more small metal tubes. One tube 130 acts as inlet for buffer liquid and directs its flow at the porous plug 121, the second (131) drains excess liquid from the cavity 120. The arrows indicate the directions of fluid flow in use. Either or both of the tubes may be metal and act as an electrode. Likewise the body 132 joining the tubes may also be metal.

If a second dimension separation is to be carried out subsequent to the first, the pressure in rear chamber 105 can be reduced, drawing the sheet 101 away from gasket 111 (see FIG. 16A). The IPG strip is then no longer isolated from the rest of the front chamber 108. Reagents to make a polyacrylamide gel can be introduced in liquid form into the front chamber (which now represents both first ad second separation zones), via the lower inlet conduit 110, to an appropriate level. This level may be such as to contact or even immerse the IPG strip. However, it is preferred that the second dimension gel be spaced from the IPG strip by a small amount, leaving an inter-zone cavity which may subsequently be filled with for example molten agarose when analyte migration to the second separation zone is desired. The agarose may be introduced through an inlet provided in the chamber 108, conveniently just below the IPG strip 102, to a level which contacts or more preferably immerses the IPG strip. According to this embodiment, the second dimension separation medium effectively comprises two regions, the upstream one of which is introduced only when analyte transfer between first and second separation zones is required. The downstream region of the second dimension separation medium may be pre-cast, ie, it may be in place during the first dimension separation.

To facilitate introduction of the second separation medium and if applicable a medium for the inter-zone cavity, one or more fluid level sensors may be incorporated into the device. A convenient form is an optical level sensor, for instance one which introduces light into the relevant fluid chamber through an appropriately shaped light guide and detects the light reflected back from an internal surface of the guide, the extent and nature of the reflection being dependent on the fluid present in the chamber in the region into which the guide extends.

Once the second dimension liquid gel has set, and if applicable a medium such as agarose has been introduced into the inter-zone cavity and allowed to solidify, the second dimension separation can be carried out, the analytes separated on the IPG strip being free to migrate into the second dimension gel under the influence of an applied electric field.

Operation of the FIG. 15 device can thus be seen to be in accordance with the sixth aspect of the present invention

Again during the second dimension separation, the gel temperature can be controlled by passing a cooling fluid through the rear chamber 105.

Uniform electrophoretic separation in the second dimension requires that the thickness of the gel is uniform across the area of the slab formed in chamber 108. If the sheet 101 is not rigidly supported then the chamber 108 may vary in thickness. One way to support the sheet is to apply a negative differential pressure (relative to front chamber 108) until the sheet is pulled firmly against the face of rear plate 104. The latter may be made accurately flat, however this will reduce the opportunity for cooling fluid to flow over the area of the sheet. Thus it may be preferable to provide narrow grooves in the inner face of plate 104, and allow the cooling liquid to flow through then The grooves are made at a spacing sufficiently small that there is adequate thermal coupling between areas of sheet 101 between the grooves and the cooling liquid.

Preferably, the plate 104 is made from a thermally conductive material, such as aluminium. This improves the flow of heat from the sheet to the cooling liquid. The conductivity of the plate 104 may be sufficiently high that liquid cooling is not required; heat may be lost through the thickness of the plate to the environment on the opposite face, aided by fins or other heat exchange devices on that face. It is important that grooves in the plate 104 are narrow so that the sheet does not deform substantially where it is unsupported. Typically, grooves may be between 0.5 and 3 mm in width.

The sheet 101 and IPG strip 102 are typically disposable items, supplied either separately to or in combination with the rest of the device. Preferably the sheet and strip are supplied as a single item which may be fitted into a reusable processing cassette comprising the remaining parts as described above.

Note that the IPG strip need not necessarily be enclosed (by the sheet 101 and gasket 111) during the first dimension separation. It may be soaked in sample-containing liquid prior to being placed in the system for electrophoretic separation. Alternatively, rehydration of the strip by sample liquid may be done in the device but without the use of a defining seal 111. Part of a device suitable for use in this way is shown in FIGS. 19 and 20.

In this arrangement, when control pressure is applied to the sheet 101, the IPG strip 102 contacts the inner face of the front block 103. Within the contact area a groove 140 is provided in the face of the plate 103. Fluids may be passed to and from this groove via one or more ports such as 141, 142. In this way, sample liquid or reagents may be brought into contact with at least part of the face of strip 102 into which they soak. Since the strip is typically permeable, the liquid may migrate to all parts of the strip. Provided that any gaps between the face of the strip and the plate 103 are small (eg, less than 0.3 mm) then the liquids may be held in contact with the strip by the action of surface tension for periods of hours without loss.

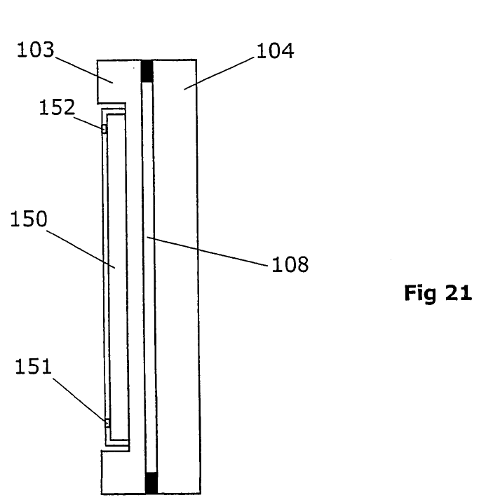

In devices such as those of FIGS. 15 to 20, the plate 103 is preferably transparent so that the electrophoresis progress and final separation may be observed without the need to dismantle the device. However, a problem can occur where heat generated in the gel leads to a temperature difference between its faces; this in turn leads to differential rates of electrophoretic separation showing as streaking of species in the final separation pattern. Preferably, cooling of the second dimension gel is symmetrical to reduce this effect. If the plate 103 has to remain transparent, then a jacket of cooling water may be added, as in the device shown in FIG. 21, in which a temperature regulating chamber 150 is provided adjacent the front plate 103. Cooling liquid may be introduced through inlet 151 and evacuated through outlet 152.

Alternatively, if viewing of the gel is not essential, then the front plate 103 may be of grooved aluminium or similar, as described above in connection with cooling of the rear plate 104. A further variant is where this latter method is used, but a small transparent window is included in the cooling plate, allowing viewing over a narrow strip. This may be particularly effective when the migration of species is to be detected optically (eg, by fluorescence of attached dyes) along a strip orthogonal to the migration direction and recorded as separation progresses. From such a recording it would be possible to mathematically synthesise a composite area image of how the species would appear after a period of separation. This may be further improved by imaging through more an one strip and recordings from the strips can be correlated on a time-dependent basis.

1. An electrophoresis device for use in separating a mixture of analytes in a fluid sample, the device comprising first and second separation zones capable of containing first and second separation media respectively through which the analytes may migrate, and barrier means by which fluid communication between the first and second zones is reversibly prevented wherein the barrier means comprises a sealing element which is reversibly deformable between two positions, in one of which a fluid-tight seal is provided between the first and second separation zones and in the other of which fluid communication between the first and second separation zones is allowed.

2. A device according to claim 1, wherein the barrier means is automatically operable.

3. A device according to claim 1 or claim 2, comprising a control chamber defined at least in part by a region of the sealing element, the arrangement being such that deformation of the sealing element may be caused by altering the pressure of a control fluid in the control chamber.

4. A device according to any one of the preceding claims, wherein the sealing element serves at least partly to define the first separation zone.

5. A device according to any one of the preceding claims, wherein the sealing element comprises a flexible diaphragm.

6. A device according to any one of claims 1 to 4, wherein the sealing element comprises a flexible sheet on one face of which the first separation medium may be carried.

7. A device according to claim 6, wherein the flexible sheet serves at least partly to define both the first and the second separation zones.

8. A device according to any one of the preceding claims, wherein the first and second separation zones are represented by the same physical space, reversibly separable into two adjacent chambers by the barrier means.

9. A device according to any one of the preceding claims, wherein the first and second separation zones are provided between two plates.

10. A device according to any one of the preceding claims, at least a portion of which is transparent, or partially so, to ultraviolet, visible and/or infra-red light.

11. A device according to any one of the preceding claims, comprising one or more inlets through which first and/or second separation media may be introduced into the first and/or second separation zones.

12. A device according to any one of the preceding claims, comprising means for applying an electric field across the first and second separation zones individually.

13. A device according to claim 12, wherein the means for applying an electric field comprises a first pair of electrodes located one at each end (along the axis of analyte separation) of the first separation zone, and a second pair of electrodes located one at each of the upstream and downstream ends (in the direction of analyte movement in use) of the second separation zone, the first and second electrode pairs being arranged to allow application of perpendicularly (or substantially so) orientated electric fields, so as to permit analyte separation in two orthogonal or substantially orthogonal directions.

14. A device according to claim 13, comprising a cavity between one or more of the electrodes and the relevant separation medium, into which cavity a fluid may be introduced so as electrically to isolate the electrode from or connect it with the other electrode of its pair depending on the conducting properties of said fluid.

15. A device according to any one of the preceding claims, additionally comprising a first separation medium contained within the first separation zone.

16. A device according to claim 15, wherein the first separation medium is carried on one face of a flexible sheet which is or forms part of the barrier means.

17. A device according to claim 16, wherein the surface area of that face of the flexible sheet which carries the first separation medium is at least 15 times that of the region of contact between the separation medium and the sheet.

18. A device according to any one of claims 15 to 17, wherein the first separation medium comprises an immobilised pH gradient (EPG) element.

19. A device according to any one of the preceding claims, additionally comprising a second separation medium contained within the second separation zone.

20. An electrophoresis device for use in separating a mixture of analytes in a fluid sample, the device being substantially as herein described with reference to the accompanying illustrative drawings.

21. Apparatus with which to carry out one or more two-dimensional electrophoretic separations, the apparatus comprising at least one electrophoresis device according to any one of the preceding claims.

22. Apparatus according to claim 21, comprising six or more electrophoresis devices according to any one of the preceding claims.

23. Apparatus according to claim 21 or claim 22, comprising control means for the automatic operation, individually, of each of a plurality of electrophoresis devices which the apparatus comprises.

24. Apparatus with which to carry out one or more two-dimensional electrophoretic separations, the apparatus being substantially as herein described with reference to the accompanying illustrative drawings.

25. Support means for an electrophoresis device according to any one of claims 1 to 20, for use as part of apparatus according to any one of claims 21 to 24, the support means comprising one or more of
(i) fluid connections by which fluid inlet(s) and outlet(s) in the electrophoresis device may be connected to fluid sources and/or sinks;
(ii) fluid flow control means associated with said fluid connections;
(iii) electrical connections by which electrically conducting elements in the device may be connected to an electrical power supply;
(iv) connections by which the device, or parts thereof, may be linked to external control means;
(v) means for regulating the temperature of the device or parts thereof; and
(vi) sample storage means and sample input means, by which a sample may be pre-loaded into the support means and subsequently introduced into the device.

26. Support means for an electrophoresis device according to any one of claims 1 to 20, the support means being substantially as herein described with reference to the accompanying illustrative drawings.

27. An assembly of two or more support means according to claim 25 or claim 26.

28. A method for separating a mixture of analytes in a sample, the method involving (i) applying the sample to a first separation medium; (ii) applying an electric field across the first separation medium so as to separate the analytes according to a first analyte property; (iii) allowing the analytes to migrate from the first separation medium onto a second separation medium under the influence of an applied electric field; and (iv) applying an electric field across the second separation medium so as to separate the analytes according to a second analyte property; wherein migration of the analytes from the first to the second separation medium is reversibly prevented during step (ii) by a barrier means comprising a fluid-tight reversibly deformable sealing element positioned between the two media.

29. A method for separating a mixture of analytes in a sample, the method involving (i) applying the sample to a first separation medium in a separation chamber in the absence of any other separation medium; (ii) applying an electric field across the first separation medium so as to separate the analytes according to a first analyte property; (iii) introducing a second separation medium into the separation chamber, adjacent or in contact with the first separation medium; (iv) allowing the analytes to migrate from the first separation medium onto the second under the influence of an applied electric field; and (v) applying an electric field across the second separation medium so as to separate the analytes according to a second analyte property wherein the first separation medium is reversibly isolated in a first separation zone during step (ii), at least partly by a barrier means comprising a reversibly deformable sealing element.

30. A method according to claim 29, wherein the second separation medium is introduced in fluid form in an amount such as to leave a cavity between the first and second separation media.

31. A method according to claim 28 or claim 29, wherein the barrier means comprises a flexible sheet on which the first separation medium is carried.

32. A method according to claims 28 to 31 which involves the use of an electrophoresis device according to any one of claims 1 to 20, and/or of apparatus according to any one of claims 21 to 24, and/or of support means or an assembly thereof according to any one of claims 25 to 27.

33 A method according to any one of claims 28 to 32, wherein the second dimension separation medium comprises two regions, of different separation media, at least the upstream one of which is introduced only when analyte migration between the first and second separation media is required.

34. A method for separating a mixture of analytes in a sample, the method being substantially as herein described with reference to the accompanying illustrative drawings.
